(19) United States
(12) Patent Application Publication
(10) Pub. No.: US 2003/0224194 A1
(43) Pub. Date: Dec. 4, 2003

(54) Polymer system for thick polymer sheets including syndiotactic polyoropylene or poly-1-butene

(75) Inventors: George D. Howell, Arlington, TX (US); Richard A. Vance, Garland, TX (US); Kenneth W. Bartz, Baytown, TX (US)

Correspondence Address: MYRON B. KURTZMAN, 4430 LYMBAR, HOUSTON, TX, 77096, US

(73) Assignee: UVTECH,L.P.

(21) Appl. No.: 09/887,307

(22) Filed: Jun. 22, 2001

Related U.S. Application Data
(60) Provisional application No. 60/273,167, filed on Mar. 2, 2001.

(51) Int. Cl. B29C 47/00

(52) U.S. Cl. 428/515; 428/500; 156/244.11

(57) ABSTRACT

The invention is a polymer system used in the formation of thick polymer sheets. The polymer system has a substitution of syndiotactic polypropylene, syndiotactic ethylene propylene copolymer or poly-1-butene for the typical isotactic polypropylene. These substitutions are present in the amount of at least 20% by weight of the total polymer content. The polymer sheet may be filled or unfilled.

### FIELD OF THE INVENTION

The present invention relates to a thick polymer sheet and a polymer system used in the formation of thick polymer sheets. Thick sheets, as defined herein, will refer to polymer sheets having thickness greater than or equal to 100 mils. More particularly, the present invention relates to thick polymer sheets having a substitution of syndiotactic polypropylene (or syndiotactic ethylene propylene copolymer) or poly-1-butene for the typical isotactic polypropylene. These substitutions are present in the amount of at least 20% by weight of the total polymer content. The polymer sheet may be filled or unfilled.

### BACKGROUND OF THE INVENTION

Polymer sheets formed of isotactic polypropylene are known and can be used for various industrial purposes, such as packaging. These isotactic polypropylene polymer sheets may be filled or unfilled. These sheets are formed using conventional polypropylene extrusion equipment including three-roll stack quenching systems. These sheets are then used in vacuum and thermoforming techniques. During sheet formation, the melted isotactic polypropylene extrudes from an extruder at melt temperatures between 390 and 450° F. The polymer is conveyed through a three-roll stack chill roller structure, as is known in the art, where it is cooled and sized to a predetermined thickness. For applications of this polymer sheet, it is desirous that the sheet be smooth and have a uniform thickness, and is free from other surface imperfections.

In addition, fillers are typically added to the isotactic polypropylene during processing of the final product. These fillers are typically added for reasons such as increased stiffness, mar resistance, flame retardancy, reduced shrinkage, cost considerations, etc.

However, isotactic polypropylene as the sole polymer is not suitable for use in the preparation of thick sheets (i.e., ≧100 mils). This is true in both the filled and unfilled applications. The isotactic polypropylene sheet used in vacuum and thermoforming processes has been limited by difficulties in both the fabrication of the sheets and in its use in the vacuum and thermoforming operations. This is in part due to the fact that isotactic polypropylene rapidly crystallizes over a narrow temperature range, namely 115-120° C. This temperature range is hard to uniformly maintain during the process of forming the sheet. It is similarly difficult to maintain this temperature in the top roll of a chill roller in a 3-roll stack process. Therefore, variations in thickness and mechanical properties (surface imperfections) of the sheets often result. The narrow crystallization range also presents difficulties (or limitations) in vacuum and thermoforming processes because the melt strength of the vacuum or thermoforming sheet decreases rapidly as the sheet approaches its melting point.

These problems worsen with the addition of fillers. The fillers generally increase the thermal conductivity of the products resulting in increased crystallization rates and higher crystallization temperatures enhancing the problems encountered with the homopolymers, such as increased stiffness. Further, the addition of the fillers presents other problems in making an extruded sheet of isotactic polypropylene.

U.S. Pat. No. 3,356,765 teaches an isotactic polypropylene sheet containing isotactic poly-1-butene. However, the isotactic polypropylene constitutes at least 75% of the polymer system. It states that for sheets having thickness above 1.5 mm (60 mil), the sheets must be cooled gradually to inhibit internal strains. The sheets must be conditioned by heating the sheet for a few minutes at a temperature ranging from about 5 to 10° C. below the melting temperature of the polymer. This further exemplifies the problems of making thick sheets using isotactic polypropylene.

U. S. Pat. No.4,886,849 to Hwo et al. teaches 60-75% by weight of isotactic butene-1 and 23.5-39.88% polypropylene with the addition of a high-density polyethylene for shapes with thickness of 20-300 mils. The high-density polyethylene is added to alter the melt index and broaden the crystallization range. However, the low end of the range is not a thick polymer sheet.

U.S. Pat. No. 5,597,522 to Curzon et al. teaches using extrusion to form a polymer tape or sheet having a thickness of 1 to 10 mm (40-400 mil). It is comprised of a polyolefin such as syndiotactic polypropylene having hollow microsphere fillers to make tapes to insulate pipes. Again, the low end of the range is not a thick polymer sheet.

U.S. Pat. No. 5,369,181 to Hwo teaches a polymer system comprising any crystallizable polypropylene (preferably isotactic) and less than 10 wt % poly-1-butene. However, this system forms a sheet having a thickness of less than 2.25 mils, which is not a thick sheet as defined herein. Hwo ′820 teaches a polymer composition having less than 10% poly-1-butene and polypropylene for sheets of thickness of 20-300 mils. As the composition does not include more than 20 percent by total polymer weight of poly-1-butene, it would encounter the difficulties as described above.

If these prior art polymer compositions were used in thick sheets as defined herein, they would result in sheets having varying thickness and mechanical properties. For example, where the chill roll/polymer contacts are too hot the sheet will tend to draw more, resulting in thin spots and possible sticking of the sheet to the roll. At cold sites of the roll, the polymer begins to crystallize, causing an increase in modulus which leads to less local draw down and increases the thickness. The higher modulus causes the sheet to pull away from the roll prematurely, resulting in further surface imperfections. These effects occur to an even greater extent in filled polymers.

### SUMMARY OF THE INVENTION

The present invention comprises a polymer sheet including the partial or complete substitution of syndiotactic polypropylene (or syndiotactic ethylene propylene copolymer) or poly-1-butene for isotactic polypropylene. The substitution of these types of polymers increases the time to crystallization and allows the material (polymer and filler) to remain pliable enough to wrap around the 3-roll stack without breaking. This is most likely due to lower and wider temperature crystallization range and slower crystallization rate verses that of the isotactic propylene alone.

In a preferred embodiment of the invention, the invention includes a polymer system for a thick polymer sheet comprising syndiotactic polypropylene (or syndiotactic ethylene propylene copolymer) in an amount greater than 20 percent to 100 percent by weight based on total polymer content; and isotactic polypropylene in an amount of 0 percent to less than 80 percent by weight based on total polymer content; wherein the polymer sheet has a thickness greater than or equal to 100 mils. The polymer system may include antioxidants and fillers. Fillers, if used, are present in an amount of 30-70 weight percent. Further, poly-1-butene may be used in place of syndiotactic polypropylene (or syndiotactic ethylene propylene copolymer) and ethylene propylene block copolymer can be used in place of the isotactic polypropylene.

Accordingly, it is an object of the present invention to provide a polymer system which improves the extrudability of thick polymer sheets; a polymer system which improves thermal and vacuum formability; a polymer system in which fillers can be added without significantly losing the advantages of the compositions.

Other objects and advantages of the present invention will be apparent from the following description, the accompanying tables and the appended claims

### BRIEF DESCRIPTION OF THE DRAWING

FIG. 1 shows a three-roll stack structure for forming an extruded polymer system into a sheet.

### DETAILED DESCRIPTION OF THE INVENTION

The invention is a polymer system for forming a thick polymer sheet. The polymer system includes syndiotactic polypropylene, syndiotactic ethylene propylene copolymer or poly-1-butene. The polymer also may include isotactic polypropylene or ethylene propylene block or random copolymer as long as the syndiotactic polypropylene (or syndiotactic ethylene propylene copolymer) constitutes at least 20 percent by weight based on polymer content of the system. Either isotactic polypropylene or the block or random copolymer may be used. However, the block copolymer provides higher impact and less stiffness and is therefore easier to work with. The polymer system also may include various antioxidants, and fillers as will be described hereinbelow.

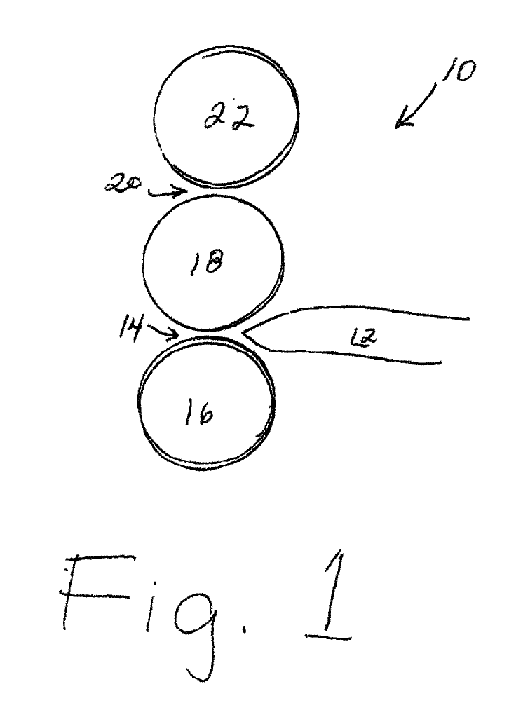

Preferably the thick polymer sheet is formed by extrusion. The thick extruded sheet of the present invention is produced on a three-roll stack chill roll either upstack or downstack. FIG. 1 shows an upstack configuration of a three-roll stack chill roll 10. In this fabrication, the polymer exudate 12 comes out of the sheet die and flows into the first nip 14 between the bottom roll 16 and the middle roll 18. The nip (or gap) 14 is adjusted for the desired thickness of the sheet. The hot exudate 12 is cooled as it wraps around the middle roll 18 and the thickness of the sheet is further adjusted at the second nip 20. The second nip 20 is the gap between the middle roll 18 and the top roll 22. The exudate is further cooled as the material comes in contact with and wraps around the top roll 22.

The problem with the prior art systems of using isotactic polypropylene, (either homopolymer or copolymer) is that when the fillers are present, the material loses heat rapidly. This heat loss causes the material to become stiff as it passes through nip 14 and contacts roll 18. This increased stiffness makes it impossible for the sheet to conform to roll 18 and pass through nip 20. Therefore, the sheet cannot make the bend around the roll without breaking. This is obviously undesirable. The classic solution to this problem is to make the top roll extremely hot, i.e., significantly hotter than the glass transition temperature of the isotactic polypropylene. In cases where thick sheet is being produced, the temperature of the top roll might be in excess of 300° F., requiring the use of either high pressure steam or hot oil. Most manufacturing plants want to avoid using pressurized water this hot because of safety concerns. Thus the fabricator's only option then becomes a change in the heating medium in the top roll from pressurized water to oil. For most fabricators this is undesirable because this involves a significant change over time to change from oil to water and back again. Further, most fabricators don't want the oil to remain in the top roll because the oil has a lower heat transfer coefficient than water, resulting in lower sheet through put rates.

The addition of syndiotactic polypropylene, syndiotactic ethylene propylene copolymer or poly-1-butene to isotactic polypropylene, increases the time necessary for crystallization and allows the material (polymer and filler) to remain pliable enough at hot water temperatures to wrap around the top roll without breaking. This improved performance of the syndiotactic polypropylene or syndiotactic ethylene propylene copolymer is most likely due to its lower and wider temperature crystallization range as well as its slower crystallization rate. These two characteristics allow the extruding sheet to maintain a more uniform and higher melt viscosity than is attainable with only the isotactic polypropylene. This uniformity is maintained throughout the roll stack resulting in a thick sheet of uniform thickness and even surface profile. Poly-1-butene performs similarly to syndiotactic polypropylene or syndiotactic ethylene propylene copolymer.

The melting characteristics of these improved sheets also improves their thermal and vacuum formability. This is due to the fact that the lower and wider crystallization ranges make for easier sheet handling and the slower crystallization results in an acceptable melt strength for a longer fabrication period. However, the crystallization rate is still fast enough to allow the material to become solid before the sheet is trimmed to size at the end of the sheet line.

By the addition of syndiotactic propylene or syndiotactic ethylene propylene copolymer and/or poly-1-butene, thick sheets have been formed which were not limited by the fabrication process. The sheets were substantially uniform in thickness and free from surface imperfections. Further, the thick filled and unfilled sheets show significant improvements in both the thermo- and vacuum forming over similar sheets made with only isotactic polypropylene.

In addition, as mentioned above, fillers may be added to the polymer system. The fillers are added in amounts of 30-70 (preferably 40-60) weight percent. Exemplary fillers include talc, calcium carbonate, magnesium hydroxide, and barium sulfate. Other fillers include mica, wollastonite, calcium oxide, clays and other fillers commonly used in polyolefins. These fillers are added for a variety of reasons such as increased stiffness, mar resistance, flame retardancy, reduced shrinkage and lower cost of the final product.

The resulting thick polymer sheet is greater than or equal to 100 mils thick. Though the following examples show thickness of 100 mils, other thickness sheets may be formed from this polymer system such as those greater than 400 mils. The thick polymer sheet may be thermoformed to make bumpers for cars or other applications.

The percent of syndiotactic polypropylene or syndiotactic ethylene propylene copolymer capable of forming a thick polymer sheet should be at least 20% by weight based on total polymer content. More particularly, 40-50 wt % or 100 weight percent are permitted in the scope of the invention.

The following non-limiting examples and tables further illustrate the various aspects of this invention.

### EXAMPLES

Extrusion of 100 mil thick sheet using the following polymer systems

The polymers, additives, and fillers are blended in a Henschel Mill. The melt is homogenized in either a Banbury or Farrel Continuous Mixer (FCM) and pelletized in either a compounding extruder or the drop extruder of the FCM. The blending and extruding of the polymer systems occurred within a temperature range of 400-480° F. The pelletized product is then extruded into sheet under the following conditions: the sheet extruder heater zones were set at 380-400° F. The material melt temperature ranged from 400-430° F. The roll temperatures of the three-roll stack ranged from 160 to 200° F.

The vacuum forming was performed on a cylindrical mold. The polymer system sheets were heated to 340-360° F. by electrical heat. The sheets were drawn four inches and the mold temperature was 80° F.

TABLE 1
Performance of 100 mil sheet made from polypropylene copolymer,
polypropylene homopolymer, syndiotactic polypropylene,
and poly-1-butene

| Example No. | 1 | 2 | 3 | 4 |
|---|---|---|---|---|
| PP copolymer | 99.9 | | | |
| PP | | 99.9 | | |
| homopolymer | | | | |
| Syndiotactic | | | 99.9 | |
| PP | | | | |
| Poly-1-butene | | | | 99.9 |
| Antioxidant1 | 0.05 | 0.05 | 0.05 | 0.05 |
| Antioxidant2 | 0.05 | 0.05 | 0.05 | 0.05 |
| Surface | US | US | Satisfactory | Satisfactory |
| thickness | (rough, | (rough, | (glossy, | (glossy, |
| Uniformity | uneven) | uneven) | uniform) | uniform) |
| Result of | US | US | Satisfactory | Satisfactory |
| vacuum | | | | |
| formability | | | | |

US is unsatisfactory.
The PP copolymer is a low MFR Basell 7823 isotactic polypropylene copolymer.
The PP homopolymer is a low MFR Basell 6801 isotactic polypropylene homopolymer.
The Syndiotactic PP is Fina EOD 9628 syndiotactic polypropylene.
The poly-1-butene is a Basell polybutylene grade number DB8310.
The antioxidant 1 is Anox 20 by Great Lakes Chemical.
The antioxidant 2 is Alkanox 240 by Great Lakes Chemical.

This shows that the complete substitution of syndiotactic polypropylene for isotactic polypropylene significantly reduces the extrusion problems caused by polymer crystallization as noted above. The polymer systems of the present invention produce a smooth glossy surface of even thickness and satisfactory vacuum formability for thick sheets (100 mils). Further, isotactic poly-1-butene is shown to behave in a manner similar to syndiotactic polypropylene.

TABLE II
Performance of 100 mil sheet made from blends of syndiotactic
polypropylene and isotactic polypropylene

| Example No. | 1 | 2 | 3 | 4 | 5 | 6 | 7 |
|---|---|---|---|---|---|---|---|
| Syndiotactic | 99.9 | 74.9 | 24.9 | 20.0 | 74.9 | 24.9 | 20.0 |
| PP | | | | | | | |
| PP copolymer | | 25.0 | 75.0 | 79.9 | | | |
| PP | | | | | 25.0 | 75.0 | 79.9 |
| homopolymer | | | | | | | |
| Antioxidant1 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 |
| Fabrication | S | S | S | US | S | S | US |
| Formability | S | S | S | US | S | S | US |

S—satisfactory
US—unsatisfactory
The Syndiotactic PP is Fina EOD 9628 syndiotactic polypropylene.
The PP copolymer is a low MFR Basell 7823 block polypropylene copolymer.
The PP homopolymer is a low MFR Basell 6801 polypropylene homopolymer.
The antioxidant1 is Anox 20 by Great Lakes Chemical.
The antioxidant2 is Alkanox 240 by Great Lakes Chemical.

This shows that satisfactory results are obtained when the syndiotactic polypropylene is present in an amount greater than 20% of the total polymer weight. That is, polymer blends having 100%, approximately 75%, and approximately 25% syndiotactic polypropylene produce satisfactory thick sheets (100 mil) having acceptable thermal vacuum formability. However, the sheets having 20% by weight of the total polymer content of syndiotactic polypropylene do not produce acceptable sheets. This example further shows that these results are the same whether the isotactic polypropylene is a copolymer or a homopolymer.

TABLE III
Performance of 100 mil sheet made from blends of
poly-1-butene and isotactic polypropylene

| Example No. | 1 | 2 | 3 | 4 | 5 | 6 | 7 |
|---|---|---|---|---|---|---|---|
| Poly-1-butene | 99.9 | 74.9 | 24.9 | 20.0 | 74.9 | 24.9 | 20.0 |
| PP Copolymer | | 25.0 | 75.0 | 79.9 | | | |
| PP | | | | | 25.0 | 75.0 | 79.9 |
| homopolymer | | | | | | | |
| Antioxidant1 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 |
| Fabrication | S | S | S | US | S | S | US |
| Formability | S | S | S | US | S | S | US |

The poly-1-butene is supplied by Basell Chemical, DP8310.
The PP copolymer is a low MFR Basell 7823 polypropylene copolymer.
The PP homopolymer is a low MFR Basell 6801 polypropylene homopolymer.
The antioxidant1 is Anox 20 by Great Lakes Chemical.
The antioxidant2 is Alkanox 240 by Great Lakes Chemical.

This example shows that similar results are found when the same amounts of poly-1-butene replace the syndiotactic polypropylene in the system.

TABLE IV
Performance of 100 mil sheets made from filled syndiotactic
polypropylene and isotactic polypropylene

| Example No. | 1 | 2 | 3 | 4 | 5 | 6 | 7 | 8 |
|---|---|---|---|---|---|---|---|---|
| Sydiotactic PP | 99.9 | 49.9 | 49.9 | 49.9 | | | | |
| PP copolymer | | | | | 99.9 | 49.9 | 49.9 | 49.9 |
| Talc | | 50.0 | | | | 50.0 | | |
| CaCO₃ | | | 50.0 | | | | 50.0 | |
| Mg(OH)₂ | | | | 50.0 | | | | 50.0 |
| Antioxidant1 | 0.05 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 | 0.05 |
| Fabrication | S | S | S | S | US | None | None | none |
| Formability | S | S | S | S | US | | | |

The Syndiotactic PP is Fina EOD 9628 syndiotactic polypropylene.
The PP copolymer is a Basell 7823 polypropylene copolymer.
The talc is Microtuff 121 by Barretts Minerals.
The calcium carbonate is Kotamite by Emery.
The magnesium hydroxide is Zerogen Vertex by Huber.
The antioxidant1 is Anox 20 by Great Lakes Chemical.
The antioxidant2 is Alkanox 240 by Great Lakes Chemical.
“None” means that the sheet could not be fabricated.

This example shows that the addition of 50 weight percent of fillers can be added without significantly losing either extrusion or formability advantages of the polymer systems as long as those systems include more than 20% syndiotactic polypropylene by weight. This example further shows that thick polymer sheets were not capable of being formed with the addition of 50% fillers when only isotactic ethylene propylene block copolymer was used.

As shown in the following table, similar results were found using poly-1-butene in place of syndiotactic polypropylene.

TABLE V
Performance of 100 mil sheet made from filled poly-1-butene
and isotactic polypropylene

| Example No. | 1 | 2 | 3 | 4 | 5 | 6 | 7 | 8 |
|---|---|---|---|---|---|---|---|---|
| Poly-1-butene | 99.9 | 49.9 | 49.9 | 49.9 | | | | |
| PP copolymer | | | | | 99.9 | 49.9 | 49.9 | 49.9 |
| Talc | | 50.0 | | | | 50.0 | | |
| CaCO₃ | | | 50.0 | | | | 50.0 | |
| Mg(OH)₂ | | | | 50.0 | | | | 50.0 |
| Antioxidant1 | 0.05 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 | 0.05 |
| Fabrication | S | S | S | S | US | None | None | none |
| Formability | S | S | S | S | US | | | |

The poly-1-butene is supplied by Basell, DB 8310.
The PP copolymer is a Basell 7823 polypropylene copolymer.
The talc is Microtuff 121 by Barretts Minerals.
The calcium carbonate is Kotamite by Emery.
The magnesium hydroxide is Zerogen Vertex by Huber.
The antioxidant1 is Anox 20 by Great Lakes Chemical.
The antioxidant2 is Alkanox 240 by Great Lakes Chemical.
“None” means that the sheet could not be fabricated.

TABLE VI
Performance of 100 mil sheets made from blends of syndiotactic
polypropylene, isotactic polypropylene and fillers

| Example No. | 1 | 2 | 3 | 4 | 5 | 6 | 7 | 8 | 9 | 10 |
|---|---|---|---|---|---|---|---|---|---|---|
| Sydiotactic PP | 49.9 | | 30.0 | 19.9 | 10.0 | 49.9 | | 30.0 | 19.9 | 10.0 |
| PP copolymer | | 49.9 | 19.9 | 30.0 | 39.9 | | 49.9 | 19.9 | 30.0 | 39.9 |
| CaCO₃ | 50.0 | 50.0 | 50.0 | 50.0 | 50.0 | | | | | |
| Mg(OH)₂ | | | | | | 50.0 | 50.0 | 50.0 | 50.0 | 50.0 |
| Antioxidant1 | 0.05 | 0.05 | 0.05 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 | 0.05 | 0.05 | 0.05 |
| Fabrication | S | None | S | S | US | S | None | S | S | US |
| Formability | S | | S | S | US | S | | S | S | US |

The Syndiotactic PP is Fina EOD 9628 syndiotactic polypropylene.
The PP copolymer is a Basell 7823 polypropylene copolymer.
The calcium carbonate is Kotamite by Emery.
The magnesium hydroxide is Zerogen Vertex by Huber.
The antioxidant1 is Anox 20 by Great Lakes Chemical.
The antioxidant2 is Alkanox 240 by Great Lakes Chemical.
“None” means that the sheet could not be fabricated.

This example shows that acceptable sheets were formed using 50% fillers in those polymer systems where the syndiotactic polymer content was greater than 20 wt % based on total polymer content. The polymer systems having 100%, 60% and approximately 40% syndiotactic polypropylene resulted in thick sheets (100 mils) having satisfactory fabrication and thermal vacuum formability. Those polymer systems having 100% isotactic polypropylene with ethylene propylene block copolymer did not.

Similar sheets having poly-1-butene in place of the syndiotactic polypropylene are shown in the example of Table VII.

TABLE VII
Performance of 100 mil sheets made from blends of
poly-1-butene, fillers and ethylene propylene block copolymer

| Example No. | 1 | 2 | 3 | 4 | 5 | 6 | 7 | 8 | 9 | 10 |
|---|---|---|---|---|---|---|---|---|---|---|
| Poly-1-butene | 49.9 | | 30.0 | 19.9 | 10.0 | 49.9 | | 30.0 | 19.9 | 10.0 |
| PP copolymer | | 49.9 | 19.9 | 30.0 | 39.9 | | 49.9 | 19.9 | 30.0 | 39.9 |
| CaCO₃ | 50.0 | 50.0 | 50.0 | 50.0 | 50.0 | | | | | |
| Mg(OH)₂ | | | | | | 50.0 | 50.0 | 50.0 | 50.0 | 50.0 |
| Antioxidant1 | 0.05 | 0.05 | 0.05 | 0.05 | 0.05 | 0.05 | 0.05 | 0.05 | 0.05 | 0.05 |
| Antioxidant2 | 0.05 | 0.05 | 0.05 | 0.05 | 0.05 | 0.05 | 0.05 | 0.05 | 0.05 | 0.05 |
| Fabrication | S | None | S | S | US | S | None | S | S | US |
| Formability | S | | S | S | US | S | | S | S | US |

The poly-1-butene is supplied by Basell, DB8310.
The PP copolymer is a Basell 7823 polypropylene copolymer.
The calcium carbonate is Kotamite by Emery.
The magnesium hydroxide is Zerogen Vertex by Huber.
The antioxidant1 is Anox 20 by Great Lakes Chemical.
The antioxidant2 is Alkanox 240 by Great Lakes Chemical.
“None” means that the sheet could not be fabricated.

Having described the invention in detail and by reference to the preferred embodiments thereof, it will be apparent that modifications and variations are possible without departing from the scope of the invention defined in the appended claims.

What is claimed is:

1. A polymer system for a thick polymer sheet comprising:
(a) Syndiotactic polypropylene or syndiotactic ethylene propylene copolymer in an amount greater than 20 percent to 100 percent by weight based on total polymer content; and
(b) Isotactic polypropylene or ethylene propylene block copolymer in an amount of 0 percent to less than 80 percent by weight based on total polymer content, wherein the polymer sheet has a thickness greater than or equal to approximately 100 mils.

2. The polymer system of claim 1 further comprising an antioxidant.

3. The polymer system of claim 2 comprising:
(a) Approximately 99.9 wt % syndiotactic polypropylene or syndiotactic ethylene propylene copolymer; and
(b) Approximately 0.1 wt % antioxidant.

4. The polymer system of claim 1 wherein the thickness is greater than 400 mils.

5. The polymer system of claim 1 comprising a blend of:
(a) Greater than 20 percent to approximately 99 percent by total polymer weight of syndiotactic polypropylene or syndiotactic ethylene propylene copolymer; and
(b) Approximately 1 percent to less than 80 percent isotactic polypropylene or ethylene propylene block or random copolymer, percent by weight based on total polymer content.

6. The polymer system of claim 5 comprising a blend of:
(a) Approximately 70-80 wt % syndiotactic polypropylene or syndiotactic ethylene propylene copolymer; and
(b) Approximately 20-30 wt % isotactic polypropylene or ethylene propylene block or random copolymer based on total polymer content.

7. The polymer system of claim 5 comprising a blend of:
(a) Approximately 40-50 wt % syndiotactic polypropylene or syndiotactic ethylene propylene copolymer; and
(b) Approximately 50-60 wt % isotactic polypropylene or ethylene propylene block copolymer based on total polymer content.

8. The polymer system of claim 1 further comprising fillers in an amount of 30-70 percent by weight of the total composition.

9. The polymer system of claim 8 wherein the fillers are selected from the group consisting of talc, calcium carbonate, magnesium hydroxide, barium sulfate, mica, calcium oxide, wollastonite, and clays.

10. The polymer system of claim 8 comprising:
(a) Approximately 50 wt % syndiotactic polypropylene or syndiotactic ethylene propylene copolymer; and
(b) Approximately 50 wt % filler.

11. The polymer system of claim 8 comprising a blend of:
(a) Syndiotactic polypropylene or syndiotactic ethylene propylene copolymer;
(b) Isotactic polypropylene or ethylene propylene block or random copolymer; and
(c) Approximately 50 wt % filler.

12. The polymer system of claim 1 wherein the polymer sheet is unfilled.

13. A thick highly-filled polymer sheet comprising:
(a) Syndiotactic polypropylene in an amount greater than 20 percent to 100 percent by weight based on total polymer content; and
(b) Isotactic polypropylene or ethylene propylene block copolymer in an amount of 0 percent to less than 80 percent by weight based on total polymer content; wherein the polymer sheet has a thickness of approximately 50-1000 mils.

14. The polymer sheet of claim 13 wherein the thickness is greater than 400 mils.

15. The polymer sheet of claim 13 wherein the polymer sheet has been formed by extrusion using vacuum and thermoforming applications.

16. A thick highly-filled polymer sheet comprising:
(a) Poly-1-butene in an amount greater than 20 percent to 100 percent by weight based on total polymer content; and
(b) Isotactic polypropylene or ethylene propylene block copolymer in an amount of 0 percent to less than 80 percent by weight based on total polymer content, wherein the polymer sheet has a thickness greater than or equal to 100 mils.

17. The polymer sheet of claim 16 wherein the thickness is greater than 400 mils.

18. The polymer sheet of claim 16 further comprising an antioxidant.

19. The polymer sheet of claim 16 further comprising fillers in the amount of 30-70 percent by weight.

20. The polymer sheet of claim 19 wherein the fillers are selected from the group consisting of talc, calcium carbonate, magnesium hydroxide, barium sulfate, mica, wollastonite, calcium oxide, and clays.
